(19) United States
(12) Patent Application Publication
(10) Pub. No.: US 2017/0225581 A1
(43) Pub. Date: Aug. 10, 2017

(54) AUTONOMOUS VEHICLE CHARGING STATION CONNECTION

(71) Applicant: Faraday&Future Inc., Gardena, CA (US)

(72) Inventors: Boaz Jie Chai, Mountain View, CA (US); Anil Paryani, Cerritos, CA (US); Eahab Nagi El Naga, Topanga, CA (US); William Alan Beverley, Lakewood, CA (US)

(21) Appl. No.: 15/057,006

(22) Filed: Feb. 29, 2016

Related U.S. Application Data
(63) Continuation-in-part of application No. 15/017,491, filed on Feb. 5, 2016.

(51) Int. Cl. B60L 11/18; H02J 7/00

(52) U.S. Cl. CPC B60L 11/1827; B60L 11/1816; B60L 11/185; H02J 7/0027; H02J 7/0026

(57) ABSTRACT

A charging station can be autonomously coupled to an electric vehicle. Sensors on the vehicle determine a location of the vehicle, and the vehicle is positioned within a connection envelope. A travel path for bringing a charging connector into contact with a charging port on the vehicle can be determined, and then the travel path is autonomously carried out.

### RELATED APPLICATIONS

This application is a continuation-in-part of U.S. patent application Ser. No. 15/017,491, filed on 5 Feb. 2016, entitled “Autonomous Vehicle Charging Station Connection,” which is hereby incorporated by reference in its entirety.

### FIELD OF THE DISCLOSURE

The present disclosure relates generally to the field of vehicle charging systems, and more specifically to autonomously connecting vehicle charging systems.

### BACKGROUND

Battery powered electric vehicles require periodic recharging. A charging station can comprise an electrical cable delivering electricity from a power source, and a connector coupled to the cable. The connector can be coupled to a charging port on the car to deliver power to the batteries.

### SUMMARY

The devices, systems, and methods disclosed herein have several features, no single one of which is solely responsible for its desirable attributes. Without limiting the scope as expressed by the claims that follow, its more prominent features will now be discussed briefly. After considering this discussion, and particularly after reading the section entitled “Detailed Description” one will understand how the features of the system and methods provide several advantages over traditional systems and methods.

In one implementation, a method for autonomous connection of a charging station to a vehicle comprises parking the vehicle in a position spaced away from the charging station in a longitudinal direction by a distance, the vehicle having a charging port and the charging station having a charging connection, aligning the charging connection with the charging port with one or more actuators configured to move the charging connection in at least a transverse and lateral direction; and, after the charging connection is aligned with the charging port in at least the transverse and lateral directions, and moving the charging connection toward the charging port in the longitudinal direction to span the distance and couple the charging connection to the charging port.

In another implementation, a method for autonomous connection of a charging station to a vehicle is provided, where the vehicle has a charging port and the charging station has a charging connection. The method comprises detecting a pulse emitted by the parked vehicle by at least two detectors on the charging station, determining a time interval between the detection of the pulse by the at least two detectors, and moving the at least two detectors in at least one direction based at least on the determined time interval.

In another implementation, a charging station for an electric vehicle comprises a movable mount, one or more actuators coupled to the mount and configured to translate the position of the mount through three dimensional space, and a charging connection coupled to the mount, the charging connection couplable to the vehicle's charge port and configured to charge the vehicle when connected to the charge port. At least two detectors are coupled to the mount, wherein the detectors are configured to receive at least one signal emitted from the vehicle. Circuitry electrically connected to the at least two detectors and the one or more actuators is configured to drive the motors in response to detection of the at least one signal.

### BRIEF DESCRIPTION OF THE DRAWINGS

The following is a brief description of each of the drawings. From figure to figure, the same reference numerals have been used to designate the same components of an illustrated embodiment. The drawings disclose illustrative embodiments and particularly illustrative implementations in the context of electric vehicles, such as hybrid and/or electric automobiles. They do not set forth all embodiments. Other embodiments may be used in addition to or instead. Conversely, some embodiments may be practiced without all of the details that are disclosed. Moreover, it is to be noted that the figures provided herein are not drawn to any particular proportion or scale, and that many variations can be made to the illustrated embodiments.

FIG. 1 is a perspective view of a vehicle and an x-axis, a y-axis and a z-axis of the vehicle according to various embodiments.

FIG. 2 is a schematic diagram of a vehicle in proximity to a charging station according to various embodiments. The front side of a charging connector is shown.

FIG. 3 is the same as FIG. 1 from the opposite angle. The front side of a vehicle's charging port is shown.

FIG. 4 is a schematic diagram of a top view of a connection envelope for connecting a charging station to a vehicle according to various embodiments.

FIG. 5 is a perspective view of a connection envelope for connecting a charging station to a vehicle according to various embodiments.

FIG. 6 is a schematic diagram of an exemplary system for autonomous connection of a charging station to a vehicle according to various embodiments.

FIG. 7A is a side view of a charging station coupling to a front of a vehicle according to various embodiments.

FIG. 7B is a side view of an exemplary charging station coupling to a back of a vehicle according to various embodiments.

FIG. 8 is a side view of an exemplary charging station illustrating movement in the x-axis and the z-axis according to various embodiments.

FIG. 9 is a perspective view of an exemplary charging station illustrating movement in the x-axis and the z-axis according to various embodiments.

FIG. 10 is a top view of an exemplary charging station illustrating movement in the x-axis and the y-axis according to various embodiments.

FIG. 11 is a side view of an exemplary charging station in a parked position according to various embodiments.

FIG. 12 is a flow diagram of an exemplary method for autonomous connection of a charging station to a vehicle according to various embodiments.

FIG. 13 is another flow diagram of an exemplary method for autonomous connection of a charging station to a vehicle according to various embodiments.

FIG. 14A is a schematic diagram of a vehicle in proximity to a charging station according to various embodiments. The front side of a vehicle's charging port is shown. The charging port may include at least one emitter.

FIG. 14B is the same as FIG. 14A from the opposite angle. The front side of a charging connector is shown. The charging port may include at least one detector.

FIG. 15A is a schematic diagram of a vehicle in proximity to a charging station according to various embodiments. The front side of a vehicle's charging port is shown. At least one emitter may be place in proximity to a charging port.

FIG. 15B is the same as FIG. 15A from the opposite angle. The front side of a charging connector is shown. The charging port may include at least one detector.

FIG. 16 is a schematic illustration showing how the movement of the charging connector in the x-direction according to some implementations.

### DETAILED DESCRIPTION

Battery powered electric vehicles (EV's) require periodic charging to replenish the charge on batteries. As used herein, the term “electric vehicle” and “EV” can refer to any vehicle that is partly (“hybrid vehicle”) or entirely operated based on stored electric power. Such vehicles can include, for example, road vehicles (cars, trucks, motorcycles, buses, etc.), rail vehicles, underwater vessels, electric aircraft, and electric spacecraft.

An EV charging station can be connected to an electric grid or other electricity generating device as a source of electric energy. Charging stations can comprise a standard residential 120 volt Alternating Current (AC) electrical socket that connects to the vehicle by a cable with a standard electrical plug at one end for connecting to the residential socket, and a vehicle-specific connector at the other end for connecting to the EV. Household chargers utilizing 240 volt AC can also be installed to reduce charging time. Commercial and government-operated charging stations can also utilize 120 volt and 240 volt AC, or can utilize a Direct Current (DC) Fast Charge system of up to 500 volts.

In manual charging systems, in order to recharge a vehicle's power source, the operator of the vehicle may have to handle a high-voltage cable or charging connector. The handling of such cables and/or connectors may be inconvenient and/or may be dangerous, during darkness or inclement weather. The cables and/or connectors may be relatively heavy and/or cumbersome to maneuver. Connectors often require an amount of force to couple and uncouple together. This may be difficult for some operators.

Electric and/or hybrid vehicles often have charge ports that are typically located along the side of the vehicle similar to gas tank inlets on combustion-engine-powered vehicles. However, in parking garages, both residential and public, it may not be practical for a charging station to be located along the side of a vehicle, particularly in parking areas designated for multiple electric vehicles where each vehicle may require a charging station. The aforementioned problems, among others, are addressed in some embodiments by the charging systems disclosed herein.

The present disclosure is generally directed to systems, methods, and devices for autonomously connecting a charging station to a vehicle. In some aspects, the vehicle may be configured to automatically drive and/or park. An automatic parking feature may be automatically initiated or triggered by a driver. The automatic driving/parking feature may position the vehicle's charging port within a connection envelope. That is to say, the vehicle may be positioned such that it is in proximity of a charging device. The charging device may include a charging connection configured to be coupled to the vehicle's charging port. The charging device may have a connection envelope. The connection envelope may be a three dimensional space that a movable charging connection can be configured to operate in.

The charging device may include a charging connection configured to move in three dimensional space. In some aspects, after the vehicle's charging port is positioned within the charging envelope by the vehicle's automatic drive and/or park systems, the charging connection itself may then be maneuvered and substantially aligned with the vehicle's charging port. In some aspects, after the charging connection is substantially aligned with the vehicle's charging port, the charging device may be configured to move the charging connection in at least one direction in order to connect and/or couple the charging connection with the vehicle's charging port. The vehicle may then be charged. After the vehicle is charged, the charging device may be configured to uncouple from the vehicle's charging port. In some aspects, the charging connection may move away from the vehicle's charging port. The charging connection may then be positioned in a stored configuration, and the vehicle can be driven away.

In an exemplary method, a first signal can be received from a first sensor on a vehicle. The signal can indicate a location of the vehicle. A first system controller can activate a self-driving mode of the vehicle, and direct movements of the vehicle using the self-driving mode to position a charging port on the vehicle within a connection envelope. A second signal can be received from a second sensor on a charging station indicating a location of the charging station. A second system controller can direct movements of the charging station to position a charging connector on the charging station in contact with the charging port within the connection envelope.

According to additional exemplary embodiments, the present disclosure can be directed to methods for autonomous connection of a charging station to a vehicle. In an exemplary method, a system controller can determine a location of a vehicle and a location of a charging station. The system controller can transmit over a network to an intelligent agent the locations of the vehicle and the charging station. The intelligent agent can determine a first travel path to reposition the vehicle such that a charging port on the vehicle is positioned within a connection envelope about the charging station. The intelligent agent can transmit over the network to the system controller the first travel path. The system controller can activate a self-driving mode of the vehicle and implement the first travel path to position the charging port within the connection envelope. The intelligent agent can determine a second travel path to reposition the charging station such that a charging connector on the charging station is in contact with the charging port within the connection envelope. The intelligent agent can transmit over the network to the system controller the second travel path. The system controller can activate movement of the charging station along the second travel path and position the charging connector in contact with the charging port within the connection envelope.

According to further exemplary embodiments, the present disclosure can be directed to systems for autonomous connection of a charging station to a vehicle. An exemplary system can comprise a vehicle comprising a charging port and a self-driving mode, and a first sensor on the vehicle to detect a location of the vehicle. The system can comprise a charging station comprising a charging connector and mechanisms to move the charging station along an x-axis, y-axis, and z-axis. The charging system can further comprise a second sensor on the charging station to detect a location of the charging station. A system controller can be communicatively coupled to the first sensor, the second sensor, the vehicle and the charging station. The system controller can be configured to activate the vehicle self-driving mode when the vehicle is in proximity to the charging station, cause the vehicle to move such that the charging port is within a connection envelope about the charging station, and cause the mechanisms to move the charging station such that the charging connector contacts the charging port within the connection envelope.

When the charging occurs outdoors (e.g., in the EV owner's driveway or at a public roadside or parking lot road station), weather conditions can make it difficult to connect the charger to the EV. During very cold periods, for example, a driver may be wearing gloves making it difficult to access the charger, grab hold of the cable and connector, open an access door on the EV charging port, and connect the cable to the charging port. Similarly, rain and snow conditions can make the connection procedure undesirable. Even if the EV owner has a charging station within a home garage, space limitations, and everyday clutter in the garage can make access to the charging station and EV charging port difficult and tedious. Time limitations can also make the connection procedure undesirable when the driver is in a hurry and does not have time to connect the charging station to the EV. A system that would automatically connect the charging station to the charging port would solve many of these problems. A fairly substantial force may be required to connect and disconnect the charging connection to the vehicle's charge port. Such force may be difficult for the elderly or disabled. It may be further desirable that such automatic connecting system be robust and inexpensive.

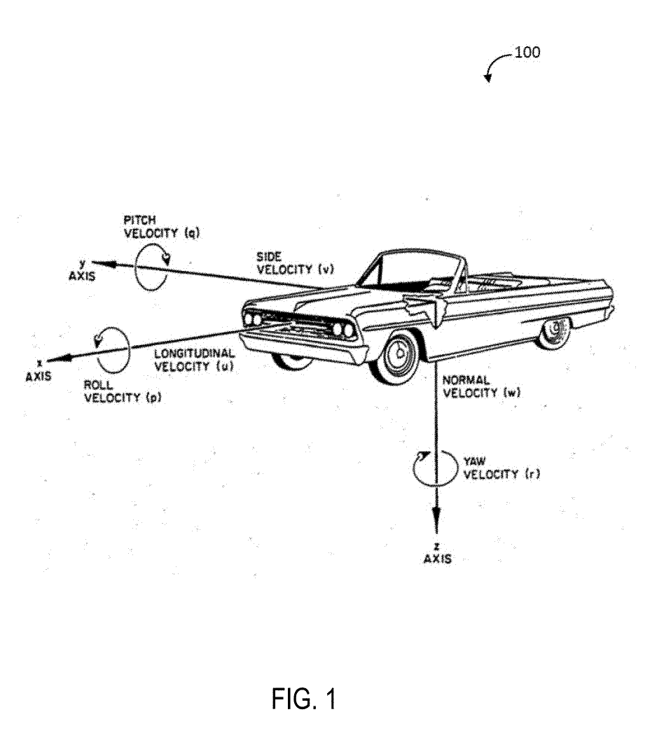

Various embodiments of an autonomous charging station can comprise movement in any direction within a three-dimensional space defined by an x-axis, a y-axis, and a z-axis. For ease of reference and consistence throughout the present disclosure, FIG. 1 illustrates the orientation of the x-axis, y-axis, and z-axis with reference to a vehicle 100. The x-axis represents movement forward and backward along a direction of travel of the vehicle 100; the y-axis represents movement to the right and left normal to the direction of travel of the vehicle 100; and the z-axis represents movement up and down normal to the plane defined by the road surface (or other surface) on which the vehicle 100 travels. The x-axis may also be referred to as the “longitudinal axis.” The y-axis may also be referred to as the “lateral axis.” The z-axis may also be referred to as the “transverse axis.” The “longitudinal direction” may refer to a direction substantially parallel to the longitudinal axis; the “lateral direction” may refer to a direction substantially parallel to the lateral axis; and the “transverse direction” may refer to a direction substantially parallel to the transverse axis.

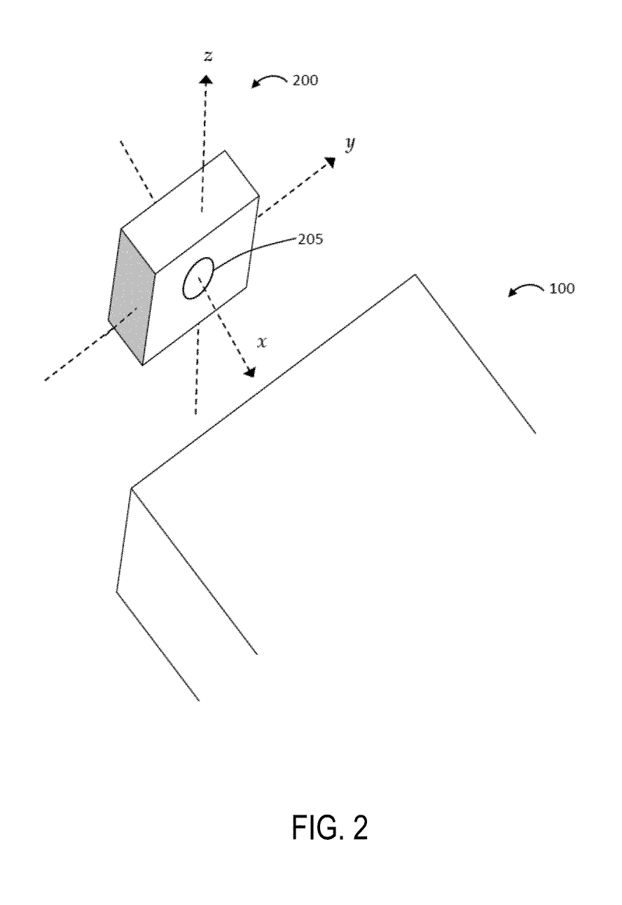

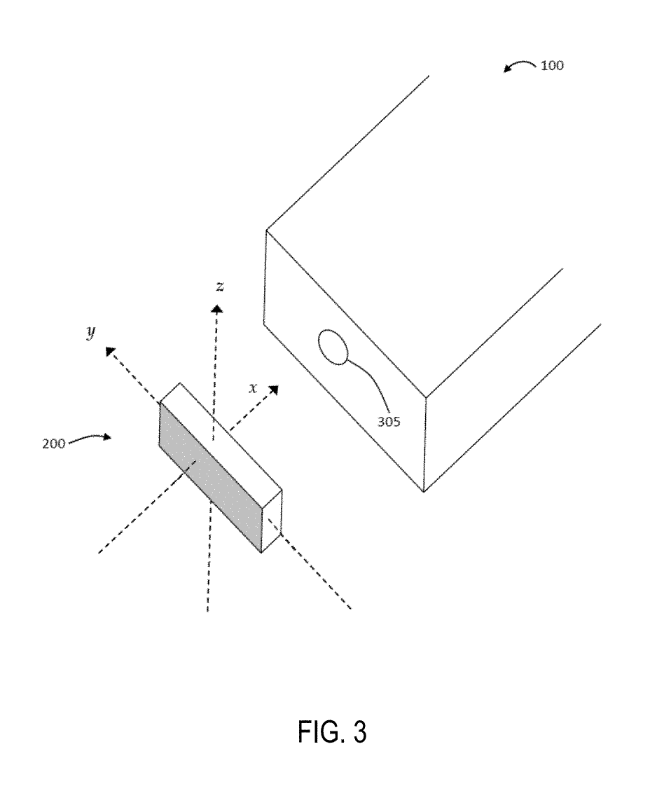

FIG. 2 schematically illustrates the vehicle 100 in proximity to a charging station 200 from the perspective of the rear of the vehicle 100, and FIG. 3 schematically illustrates the vehicle 100 and charging station 200 from the perspective of the front of the vehicle 100 according to various embodiments. The vehicle 100 can comprise a charging port 305, and the charging station 200 can comprise a charging connection 205. A desired result according to various embodiments can be the coupling and uncoupling of the charging connector 205 with the charging port 305. Such a connection can be accomplished by moving the charging connector 205 within the three-dimensional space defined by the x-axis, y-axis and z-axis.

The terms “front” and “rear” as used herein are merely descriptive and are not limiting in any way. It is not to be implied that the charging port 305 can be located only on the front or rear of the vehicle 100. In actual practice, the charging port 305 can be located at any point on or within the vehicle 100 and any such location is within the scope of the present disclosure. The terms “upper,” “lower,” “top,” “bottom,” “underside,” “upperside” and the like, which also are used to describe the disclosed methods, systems , and devices are generally used in reference to the illustrated orientation of the embodiment.

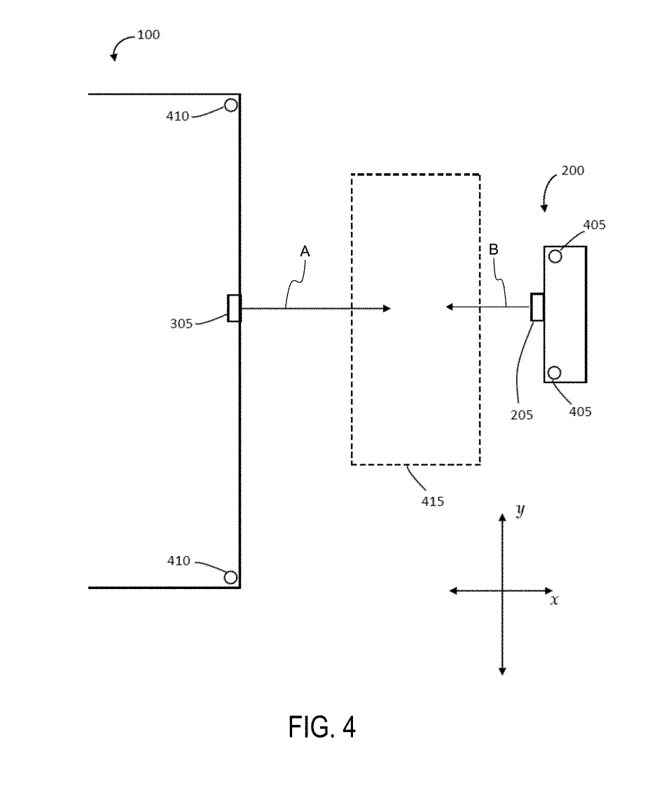

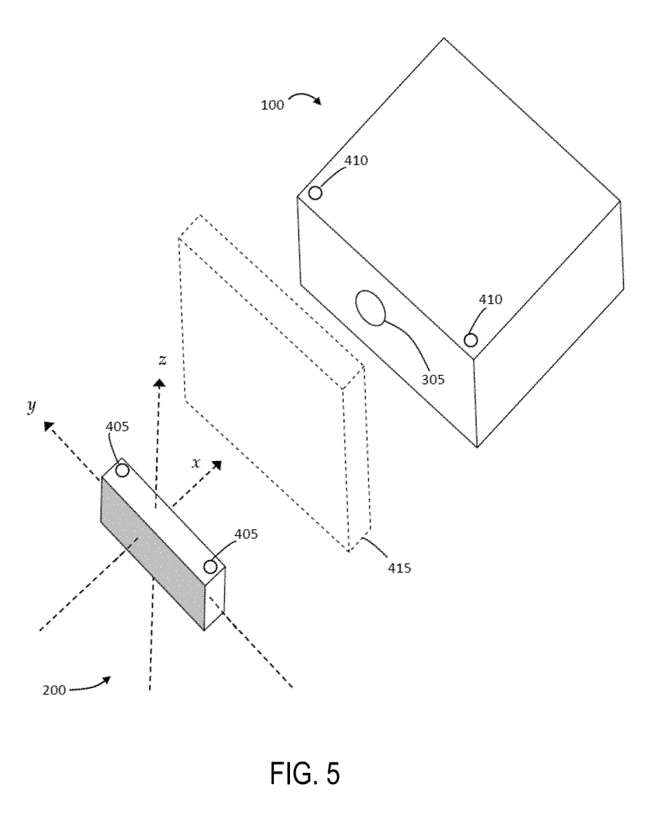

In various embodiments, movement of the charging station 200 (or a portion of the charging station 200 comprising the charging connector 205) can be limited due to mechanical constraints. These limitations can define a connection envelope 415 as illustrated schematically in FIG. 4 according to various embodiments. In order for the charging connector 205 to couple with the charging port 305, the charging port 305 can be positioned within the connection envelope 415. FIG. 4 schematically illustrates an overhead view of the vehicle 100 and the charging station 200, and the connection envelope 415 therebetween. According to various embodiments, FIG. 5 schematically illustrates that the connection envelope 415 can be a 3-dimensional space. Although FIGS. 4 and 5 represent the connection envelope 415 as a rectangular block, the connection envelope 415 can be any shape, limited only by the mechanical movement constraints of the charging station 200. For example, the shape of the connection envelope 415 can be spherical, ovoid, curved, arched, and the like.

In some aspects, the charging port on the automobile may also be configured to move with respect to the vehicle. That is to say, the charging port may be configured to move in three-dimensional space with respect to the vehicle and into the connection envelope 415.

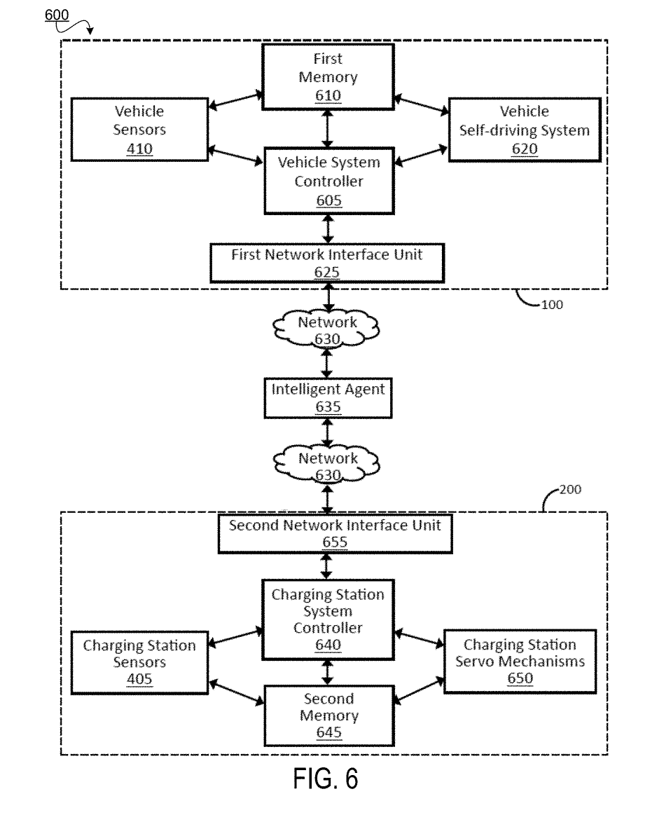

Some embodiments, as illustrated in FIG. 6 along with FIGS. 1 through 5, can comprise an autonomous system 600 for coupling the charging station 200 to the vehicle 100. The vehicle 100 can comprise a vehicle system controller 605 communicatively coupled to a first memory 610, one or more vehicle sensors 410, and a vehicle self-driving system 620. The charging system 200 can comprise a charging station system controller 640 communicatively coupled to a second memory 645, one or more charging station sensors 405, and one or more charging station servo mechanisms 650. The charging station system controller 640 may comprise circuitry configured to determine the orientation of the charging connector 205 and/or other portions of the charging station using, for example, sensors 405. Such circuitry may also be configured to move the charging connector 205 by controlling, for example, one or more actuators or servo mechanisms 650.

Referring to FIG. 4, the vehicle 100 can be brought into proximity of the charging station 200, either through the efforts of the driver of the vehicle 100 or by the vehicle self-driving system 620. The vehicle 100 can further comprise a first network interface unit 625 communicatively coupled to the vehicle system controller 605, through which the vehicle system controller 605 can communicate via a network 630 with one or more intelligent agents 635. The network 630 can be a cellular network, the Internet, an Intranet, or other suitable communications network, and can be capable of supporting communication in accordance with any one or more of a number of protocols, such as general packet radio service (GPRS), Universal Mobile Telecommunications System (UMTS), Code Division Multiple Access 2000 (CDMA2000), CDMA2000 IX (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth, Wireless LAN (WLAN) protocols/techniques.

The charging station 200 can further comprise a second network interface unit 655 communicatively coupled to the charging station system controller 640, through which the charging station system controller 640 can communicate via the network 630 with the one or more intelligent agents 635, thus allowing communication between the vehicle system controller 605 and the charging station system controller 640.

Each of the vehicle system controller 605 and the charging station system controller 640, according to various embodiments, can comprise a specialized chip, such as an ASIC chip, programmed with logic as described herein to operate the elements of the autonomous system 600. The programmed logic can comprise instructions for operating the vehicle 100 and the charging station 200 in response to one or more inputs.

Continuing with FIG. 4, the vehicle sensors 410 can comprise one or more locational sensors 410 to determine a location of the vehicle 100. The locational sensors 410 can be a global position system (GPS) sensor 410. The locational sensors 410 can also comprise ultrasonic emitters and receivers, magnetometers, cameras or other imaging devices, or the like. The vehicle system controller 605 can communicate the location of the vehicle 100 to the intelligent agent 635. The charging station 200 can comprise one or more sensors 405 that can comprise locational sensors 405 as described above to determine a location of the charging station 200, a location of the charging connector 205, and boundaries of the connection envelope 415. The charging station system controller 640 can communicate the location of the charging station 200, the location of the charging connector 205, and boundaries of the connection envelope 415 to the intelligent agent 635.

The location of the vehicle can be stored in the first memory 610 or in the vehicle sensor 410. The location can be in the form of latitude and longitude coordinates, Universal Transverse Mercator (UTM) coordinates, Military Grid Reference System (MGRS) coordinates, United States National Grid (USNG) coordinates, Global Area Reference System (GARS) coordinates, World Geographic Reference System (GEOREF) coordinates, or any other geographic coordinate system.

The intelligent agent 635, using the location inputs from the vehicle system controller 605 and the charging station system controller 640, can determine one or more movements of the vehicle 100 (e.g., a first travel path indicated by a first arrow A in

FIG. 4) to position the charging port 305 within the connection envelope 415. The intelligent agent 635 can communicate the first travel path to the vehicle system controller 605, which can then activate a self-driving mode of the vehicle self-driving system 620. The vehicle self-driving system 620, in conjunction with inputs from the vehicle sensors 410 and, in some embodiments, inputs from the charging station sensors 405, can carry out the first travel path and position the charging port 305 within the connection envelope 415.

Once the vehicle self-driving system 620 carries out the first travel path and brings the vehicle 100 to a stop and deactivates the vehicle self-driving system 620, the vehicle system controller 605 can receive further inputs from the vehicle sensors 410 to verify that the charging port 305 is positioned within the connection envelope 415. The vehicle system controller 605 then communicates the verification to the intelligent agent 635 along with the current location of the charging port 305 in 3-dimensional space within the connection envelope 415.

The charging station system controller 640 can receive input from the charging station sensors 405 and determine the location of the charging connector 205 and communicate the location to the intelligent agent 635. The input from the charging station sensors 405 may indicate a location relative to the connection envelope 415. Alternatively, the input from the charging station sensors 405 may indicate a location of the charging connector 205 with respect to other references, such as a global reference system provided by a GPS sensor. The charging station system controller 640 can then determine the location of the charging connector 205 relative to connection envelope 415 based on the input from the charging station sensor 405. The intelligent agent 635 can then determine one or movements of the charging station 200 or portion of the charging station 200 (e.g., a second travel path indicated by arrow B in FIG. 4) to position the charging connector 205 into contact with the charging port 305 within the connection envelope 415. The intelligent agent 635 can communicate the second travel path to the charging station system controller 640, which can then activate the one or more charging station servo mechanisms 650. The charging station servo mechanisms 650, in conjunction with inputs from the charging station sensors 405 and, in some embodiments, inputs from the vehicle sensors 410, can carry out the second travel path and position the charging connector 205 in contact with the charging port 305 within the connection envelope 415.

The vehicle system controller 605 can receive inputs from the vehicle sensors 410, and the charging station system controller 640 can receive inputs from the charging station sensors 405 to verify the connection between the charging connector 205 and the charging port 305. The verification can be communicated to the intelligent agent 635, which can initiate charging of the batteries in the vehicle 100. Once the charging is complete, the vehicle sensors 410 can send a signal to the vehicle system controller 605 verifying the completion of a charging cycle. The vehicle system controller 605 can then communicate the verification to the intelligent agent 635, which can then determine one or more movements (e.g., a third travel path) to move the charging connector 205 away from the charging port 305 and return the charging station 200 to a standby or parked position.

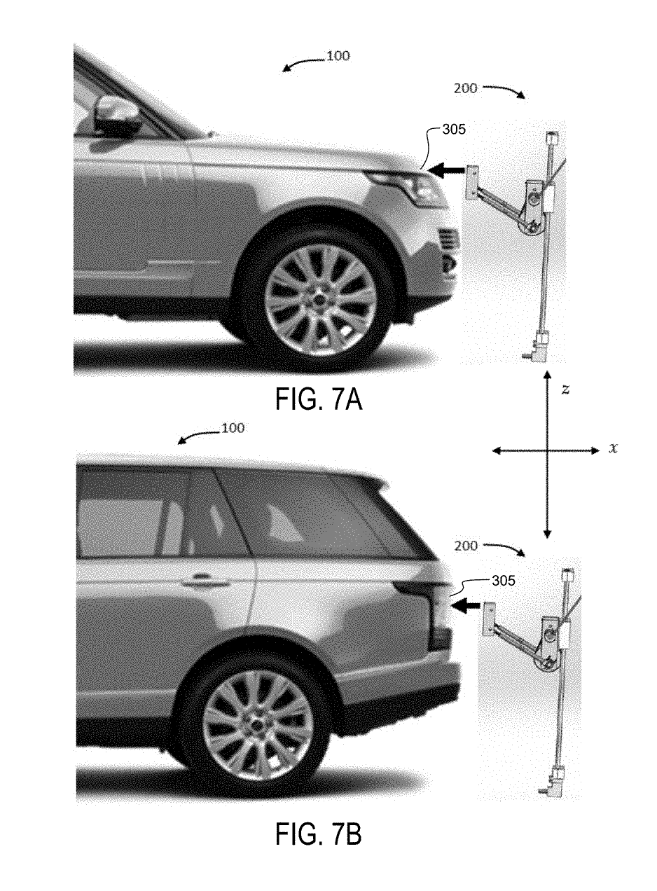

FIGS. 7A and 7B, and FIGS. 8 through 11 illustrate an exemplary charging station 200 according to various embodiments. FIGS. 7A and 7B illustrate that the charging port 305 can be located anywhere on the vehicle 100, such as a front of the vehicle 100 as illustrated in FIG. 7A or a back of the vehicle 100 as illustrated in FIG. 7B. Additionally, the charging port 305 can be positioned on the vehicle 100 at any height along the z-axis so long as the height does not exceed a height of the connection envelope 415 (see FIG. 5).

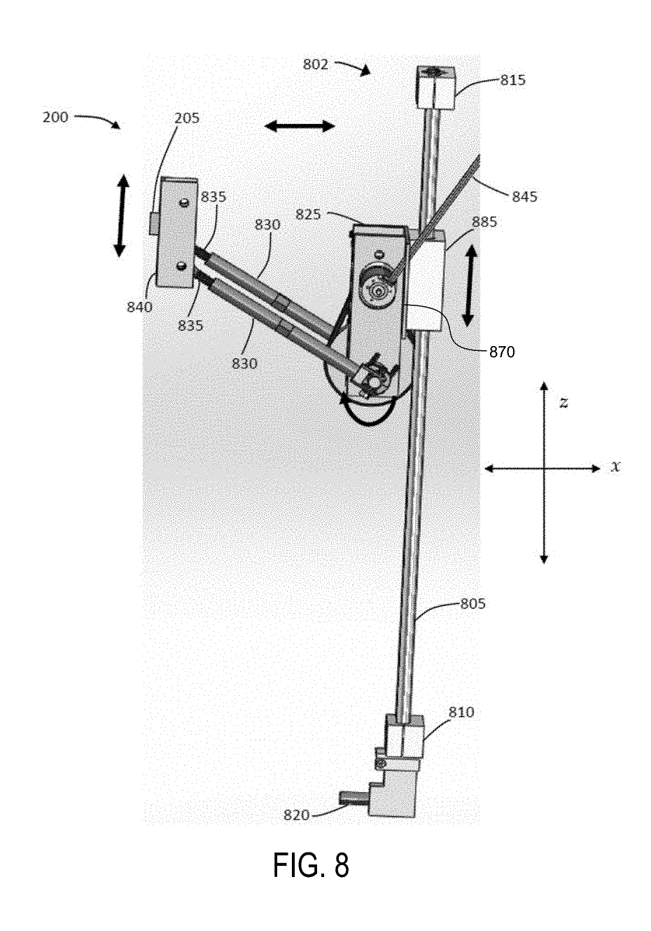

Referring now to FIGS. 8 through 10, the exemplary charging station 200 can comprise a mounting system 802 comprising a lower mounting block 810 and an upper mounting block 815 that can be coupled to a wall, post, or other structure for mechanical stability. One or more vertical guide arms 805 can extend between the lower and upper mounting blocks 810, 815. Some embodiments can further comprise a linear actuator 885 riding on the one or more vertical guide arms 805 and driven by a vertical linear actuator shaft 890 to provide movement along the z-axis. The vertical linear actuator shaft 890 can be oriented parallel to the one or more vertical guide arms 805 and held in place by the lower and upper mounting blocks 810, 815. A first plate 870 can be coupled to the linear actuator 885 and can travel along with the linear actuator 885 along the z-axis. The first plate 870 can be oriented in the y-z plane. As will be described in greater detail below, the linear actuator 885 can translate the charging connector 205 in the z-direction in order to help align the charging connector 205 to the vehicle's charge port.

The charging connector 205 may include one or more electrically contactors configured to transmit AC or DC current. The charging connector 205 may also include one or more data contactors. The data contactors may be configured to couple with one or more data contactors within the vehicles charge port. In this way, data such as charging information, battery temperature, internal cabin temperature of the vehicle, and the like may be transmitted from the vehicle to the charging station. In other embodiments, the charging station and the vehicle may be configured transmit data wirelessly with one another. The mounting system 802 can further comprise a power cable 845 for delivering an electrical current to the charging connector 205.

In some aspects, the charging connector 205 may be removably coupled to the charging station. That is to say, it may be desirable to remove the charging connector 205 from the mounting system 802. In this way, the charging connector 205 may be manually removed from the mounting system 802 and manually coupled to the vehicle' s charging port.

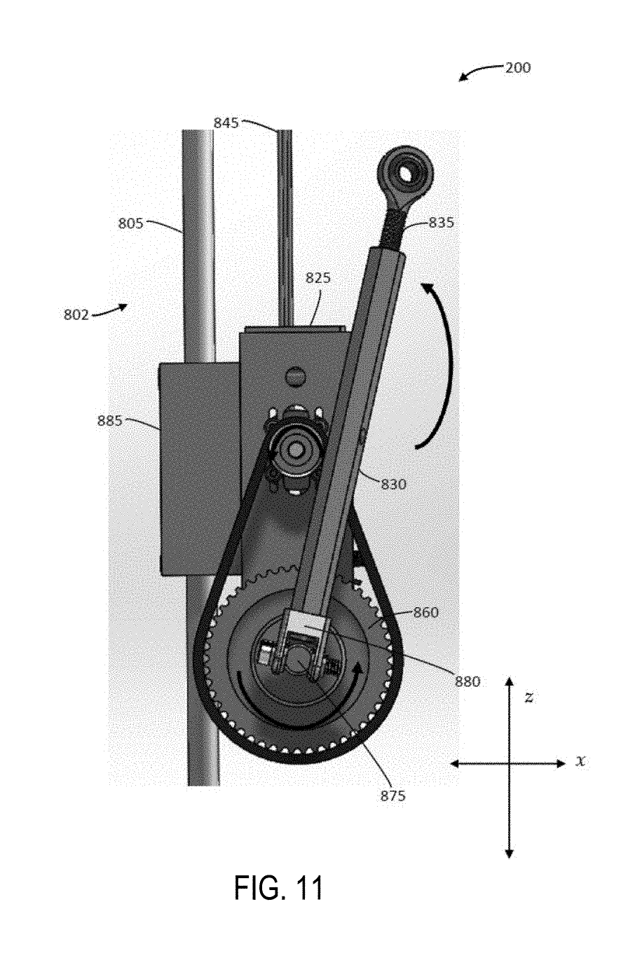

The mounting system 802 may also include an actuator unit 825 comprising one or more actuators to affect further movement of the charging unit 200. The actuator unit 825 can be coupled to the first plate 870. As best shown in FIG. 11, the actuator unit 825 may comprise a rotatable shaft 875 oriented along the y-axis. Each end of the shaft 875 may be coupled to horizontal arms 830 by a pivotable joint 880. The pivotable joints 880 may be clevis joints which use bronze bushings to allow for low sliding friction and low-tolerance moving parts, although it is to be understood that other suitable pivot joints may be used. Horizontal arm lead screws 835 may extend outward from an end of each horizontal arm 830 opposite the pivotable joint 880. The lead screws 835 can be driven from within the horizontal arm 830 such that the lead screw 835 is extendable and retractable along an axis of the horizontal arms 830. Each of the lead screws 835 can be coupled to a fixture block 840, and a second plate 865 can be disposed between the fixture blocks 840. The charging connector 205 can be coupled to the second plate 865.

In various embodiments, the actuator unit 825 can comprise a first actuator 850 coupled to a belt and pulley mechanism 860. The pulley can be coupled to a shaft 875 such that when the first actuator 850 moves the belt, the pulley rotates and causes the shaft 875 to rotate. The shaft 875 uses ball bearings for shaft support and low rolling resistance. The rotational movement of the shaft 875 can cause the horizontal arms 830 to move up or down as indicated by the vertical arrow in FIG. 8, thereby changing the position of the charging connector 205 along the z-axis. The rotational movement of the shaft 875 causes the horizontal arms 830 to translate the position of the charging connector 205 along an arc in the z-x plane. Thus, the movement of the shaft 875 may also cause the charging connector 205 to move change position along the x and z axes.

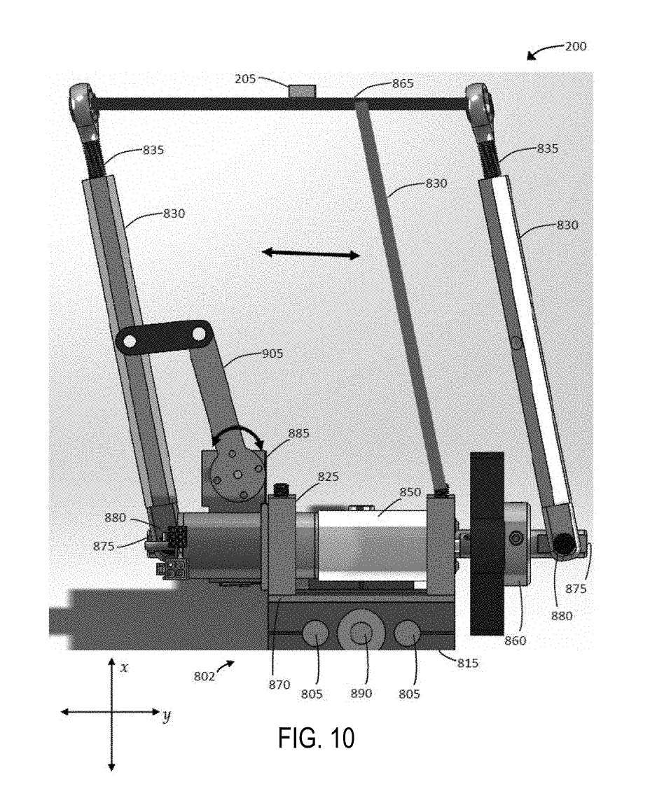

The actuator unit 825 can further comprise a second actuator 855 coupled to one of the horizontal arms 830 by a linkage mechanism 905. The second actuator 855 can cause one of the linkages in the linkage mechanism 905 to move in an arc as indicated in FIG. 10. Movement of the linkage mechanism 905 can cause the horizontal arms 830 to move left and right along the y-axis as viewed in FIG. 10.

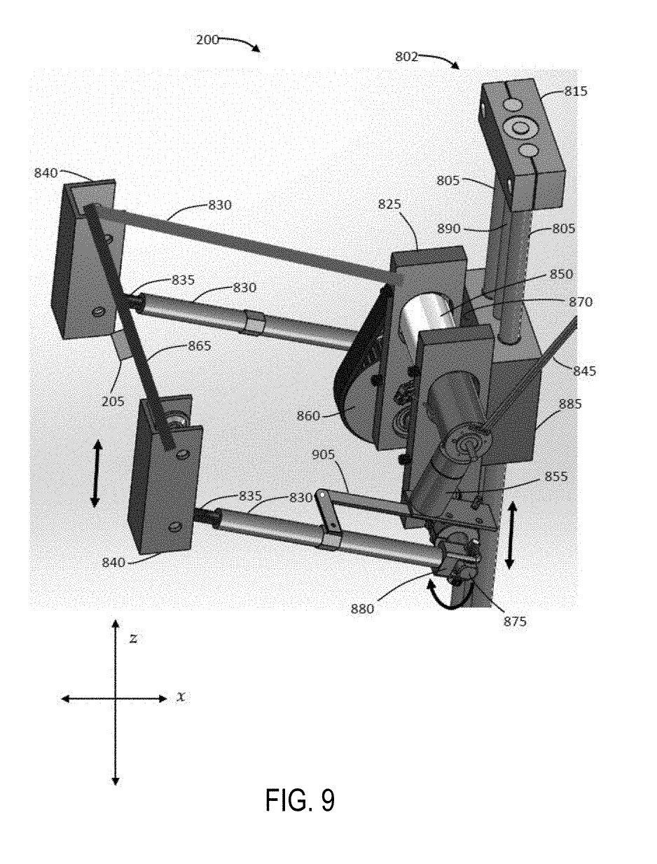

The charging station 200 can further comprise at least one additional horizontal arm 830 coupled to the actuator unit 825 (or alternatively to the first plate 870) and the second plate 865. As illustrated according to various embodiments in FIG. 9, the third horizontal arm 830 can be positioned parallel to the other horizontal arms 830, but not in the same plane. The third horizontal arm 830 can provide additional structural support and resist twisting of the structure formed by the other two horizontal arms 830 and the second plate 865. The first plate 870 and the second plate 865 may be kept parallel by the combination of the horizontal arms 830.

As described previously, the charging station system controller 640 can direct the first and second actuators 850, 855 and the lead screws 835 to initiate movements such that the charging connector 205 is positioned in contact with the charging port 305 when the charging port 305 is positioned within the connection envelope 415.

FIG. 11 illustrates the charging system 200 in a parked or stand-by position where the horizontal arms 305 are rotated by the first actuator 850 to a maximum upward (or alternatively, downward) position. This parked position can allow more unencumbered movement around the charging station 200 when not in use. Power cord 845 can provide electrical power to the actuators 850, 855, the lead screws 835, and the linear actuator 885.

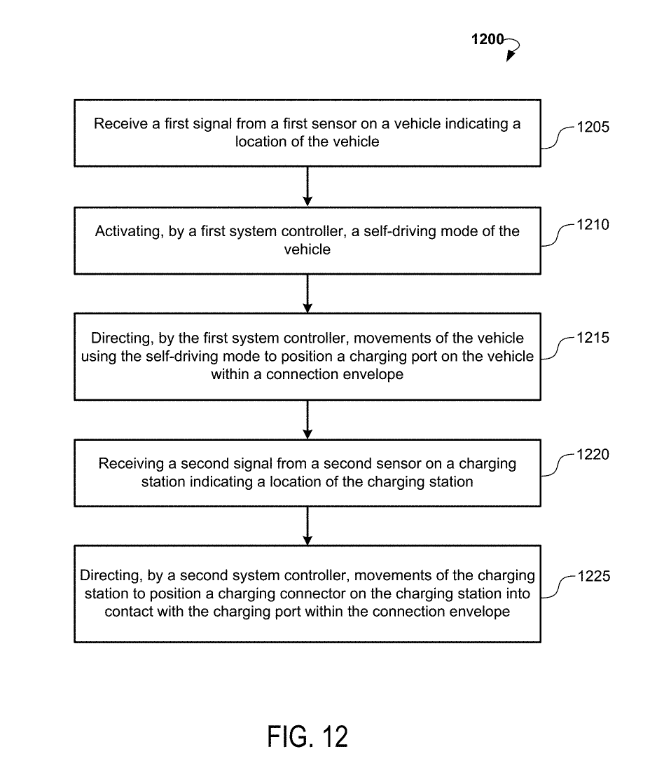

FIG. 12 is a flowchart of an exemplary method 1200 for autonomous connection of a charging station 200 to a vehicle 100 according to various embodiments. At step 1205, a first signal can be received from a first sensor 410 on the vehicle 100. The signal can indicate a location of the vehicle 100. At step 1210, a first system controller 605 can activate a self-driving mode of a vehicle self-driving system 620, and at step 1215 direct movements of the vehicle 100 using the self-driving mode to position a charging port 305 on the vehicle 100 within a connection envelope 415. At step 1220, a second signal can be received from a second sensor 405 on the charging station 200 indicating a location of the charging station 200. A second system controller 640 can direct movements of the charging station 200 to position a charging connector 205 on the charging station 200 into contact with the charging port 350 within the connection envelope 415 at step 1225.

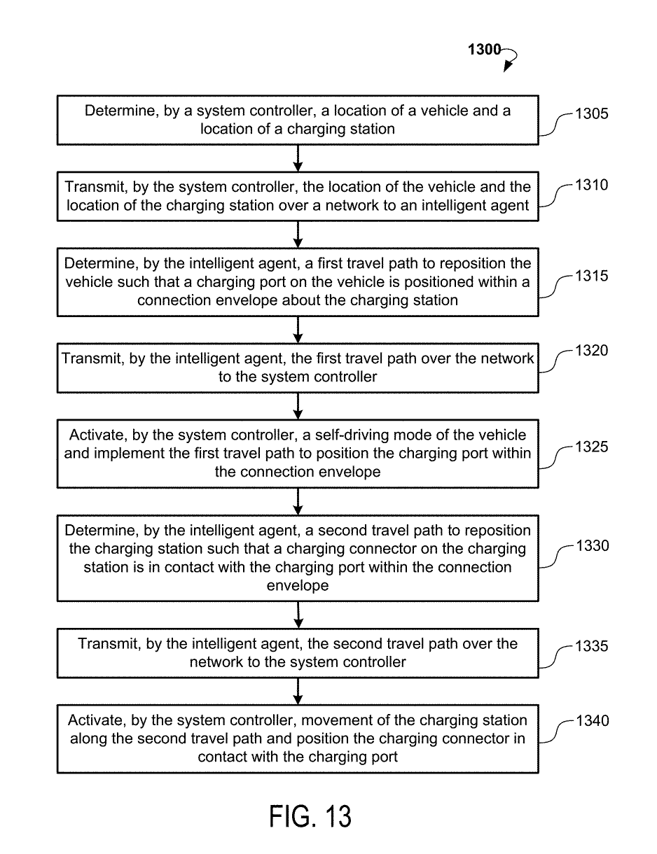

FIG. 13 is a flow chart of an exemplary method 1300 for autonomous connection of a charging station 200 to a vehicle 100 according to various embodiments. At step 1305, a system controller 605 can determine a location of the vehicle 100 and a location of the charging station 200. The system controller 605 can transmit the locations of the vehicle 100 and the charging station 200 over a network 630 to an intelligent agent 635 at step 1310. The intelligent agent 635 can determine at step 1315 a first travel path to reposition the vehicle 100 such that a charging port 305 on the vehicle 100 is positioned within a connection envelope 415 about the charging station 200. At step 1320, the intelligent agent 635 can transmit the first travel path over the network 630 to the system controller 605. At step 1325, the system controller 605 can activate a self-driving mode of a vehicle self-driving system 620 and implement the first travel path to position the charging port 305 within the connection envelope 415. At step 1330, the intelligent agent 635 can determine a second travel path to reposition the charging station 200 such that a charging connector 205 on the charging station 200 is in contact with the charging port 305 within the connection envelope 415. At step 1335, the intelligent agent 635 can transmit the second travel path over the network 630 to the system controller 605. The system controller 605 can activate movement of the charging station 200 along the second travel path and position the charging connector 205 in contact with the charging port 305 within the connection envelope 415 at step 1340.

In some implementations, the charging connection may be aligned with the charging port using at least one emitter on the vehicle and two or more detectors on the charging station. In some aspects, the emitter is configured to emit sound waves (e.g.

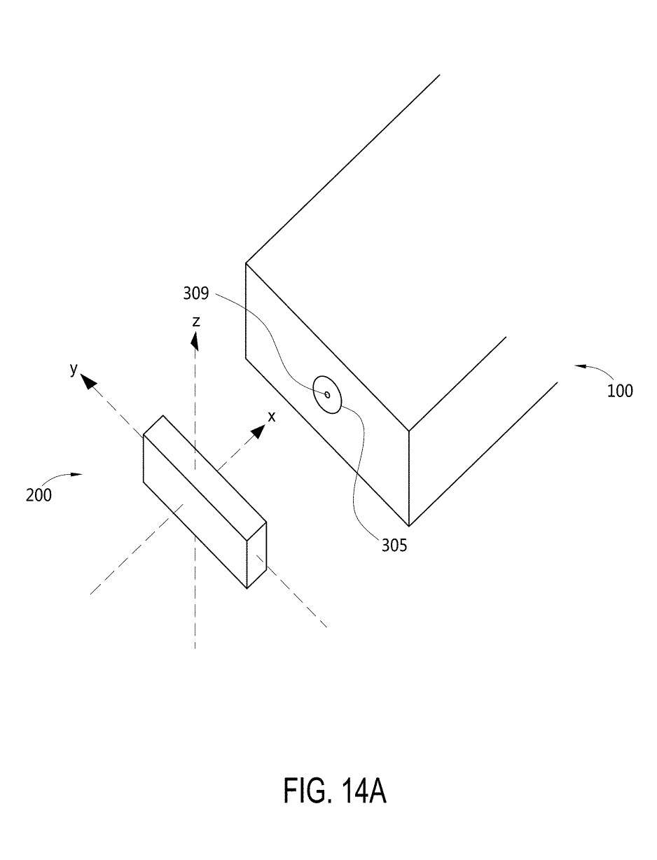

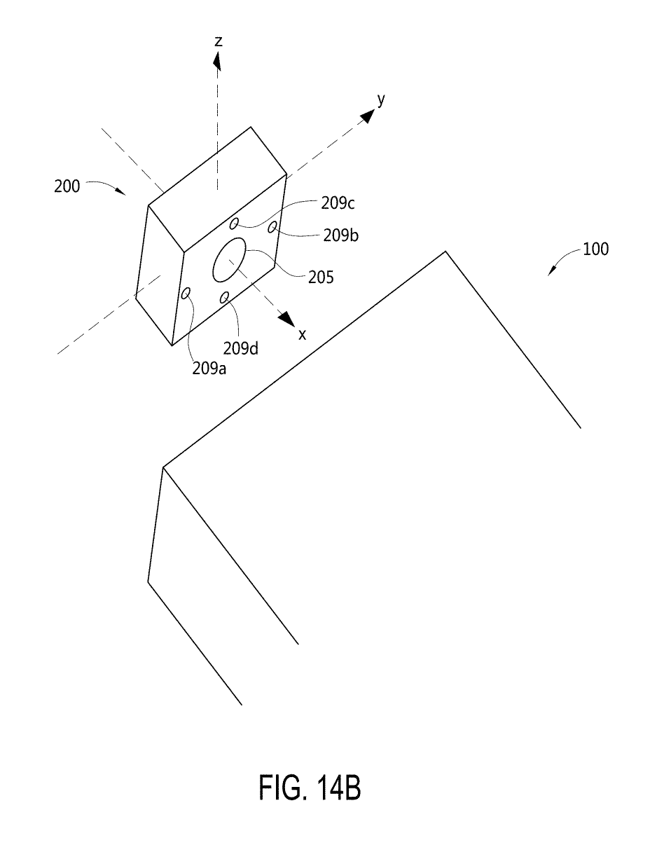

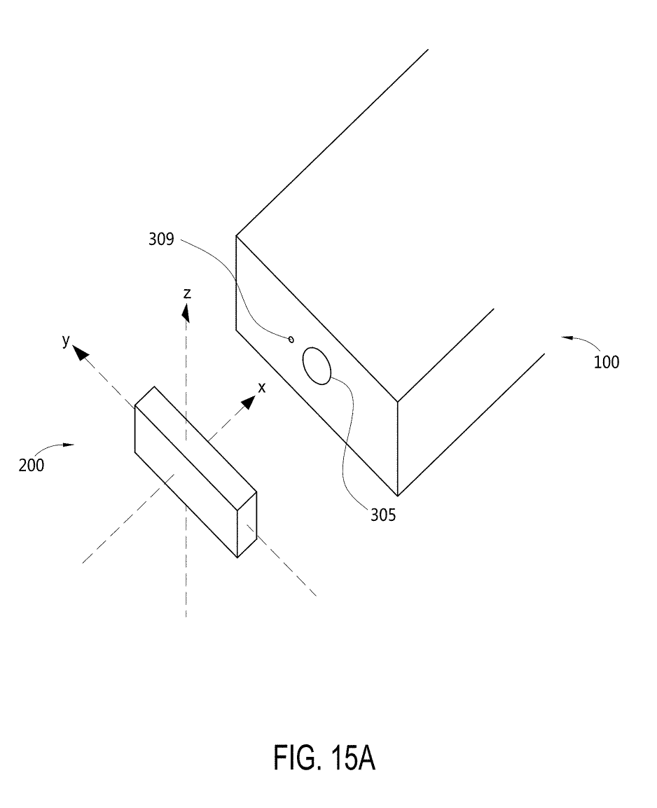

ultrasound waves). The emitter may be located anywhere on the vehicle. In some aspects, the emitter is located on or near the vehicle's charge port. The emitter may be located within the vehicle's front or rear bumper. The emitter may be a separate dedicated emitter or may be an emitter that is also used in automated parking/driving systems. The emitter may be an emitter that is used to help determine the location of a vehicle's bumper with another object. As shown in FIG. 14A, the emitter 309 may be located in the center of the vehicle's charge port 305.

Turning to FIG. 14B, two or more detectors 209 may be configured to detect the output of the emitter 309. In some aspects, the detectors 209 are configured to detect and/or record sound waves (e.g. ultrasound waves). In some aspects, at least two detectors 209 are spaced apart along the x, y, or z axis. For example, as shown in FIG. 14B, detector 209a and 209b are spaced apart from one another in the y-direction. Detectors 209c and 209d are spaced apart from one another in the z-direction. The detectors 209 may be located anywhere on the charging station 200. Generally, the detectors 209 are located on a movable portion of the charging station such as, for example, on fixture block 840 (shown in FIG. 8). As described above, fixture block 840 can be moved in the x, y, and z direction by the mounting system 802. In this way, the charging connection 205 can also be moved in the x, y, and z direction.

In the exemplary implementation shown in FIGS. 14A-14B, the detectors 209 may be used as follows. Detectors 209a and 209b, spaced apart from one another along the y-axis, may be configured to listen for a pulse emitted by the emitter 309. Circuitry may be used to determine which of the detectors 209a or 209b detects the pulse first. The detector 209a, 209b that detects the pulse first is closer to the emitter 309 in the y-direction. The charging connection 205 may then be moved in the y-direction until both of the detectors 209a, 209b detect the pulse at the same time or at least substantially the same time according to tolerance parameters. When the detectors 209a, 209b detect the pulse at the same time, the detectors 209a, 209b are equidistant to the emitter 309 in the y-direction. In this way, the charging connection 205 may be aligned with the charging port 305 in the y-direction.

Continuing with FIGS. 14A-14B, detectors 209c and 209d, may be spaced apart from one another along the z-axis and may be configured to listen for the pulse emitted by the emitter 309. Circuitry may be used to determine which of the detectors 209c or 209d detects the pulse first. The circuitry may be part of the charging station system controller 640 (shown, for example, in FIG. 6). The detector 209c, 209d that detects the pulse first is closer to the emitter 309 in the z-direction. The charging connection 205 may then be moved in the z-direction until both of the detectors 209c, 209d detect the pulse at the same time or at least substantially the same time according to tolerance parameters. When the detectors 209c, 209d detect the pulse at the same time, they are equidistant to the emitter 309 in the z-direction. In this way, the charging connection 205 may be aligned with the charging port 305 in the z-direction.

It is to be understood that while the detectors may be moved in at least one direction and stopped when the detectors detect the pulse at the same time or at least substantially the same time according to tolerance parameters, other implementations are possible. The implementation, described above, wherein an emitter is aligned in the center of two detectors that are spaced apart in one direction may be varied. For example, it may be desirable to position the two detectors such that the emitter is not in the center of the two detectors but offset from center by a desired amount when the charging connection is substantially aligned with a charge port along at least one axis. Thus, the circuitry may be configured to stop the movement of the detectors when a first detector detects the emitted pulse at a set internal of time prior to being detected by the second detector. Thus, in some embodiments, the circuitry may be configured to determine the location of the emitter based at least in part on the relative time difference that a pulse is detected by the detectors. In addition, the circuitry may be configured to determine the direction and/or distance that the detectors should be moved in based at least in part on the relative time difference between the detection of the pulse.

With the charging connection 205 aligned, or substantially aligned according to tolerance parameters, with the charging connection 205 may then be moved in the x-direction, towards the charging port 305—coupling the charging connection 205 with the charging port 305. In some aspects, the relative distance in the x-direction between the may be determined or estimated by one or more detectors (not shown). Such detectors may include image processing, lasers, ultrasound, and the like.

In some aspects, the vehicle's automated drive/park feature may position the vehicle such that the vehicle's charge port is within a set, known distance range from the charging connection 205 in the x-direction. For example, the vehicle may be configured to park about a half a meter of less (along the x-axis) from the charging connection 205 and/or charging station 200. In some aspects, the vehicle is configured to position the charging port about 25-50 cm, in the x-direction, from the charging connection 205 and/or charging station 200. In this way, the charging station will know how far to move the charging connection 205 in the x-direction. Thus, the charging connection 205 may be moved in along the y and z axis until aligned and then moved in relative fixed distance in the x-direction to couple to charging connection 205 to the charging port 305.

While the described implementations discuss determining the relative times that the detectors receive the pulse from the emitter, other solutions are contemplated. For example, the detectors may be configured to determine the relative strength of the pulse and/or signal that is detected at the two detectors. The detector that detects a stronger pulse and/or signal may be the detector that is closest to the emitter. The detector that detects the weaker pulse and/or signal may in turn be moved in the direction of the strongest signal. When the pulse and/or signal detected at each detector is relatively the same strength, the charging connection may be substantially aligned with the charge port along at least one axes. Signal strength could include magnetic and/or electric field strength.

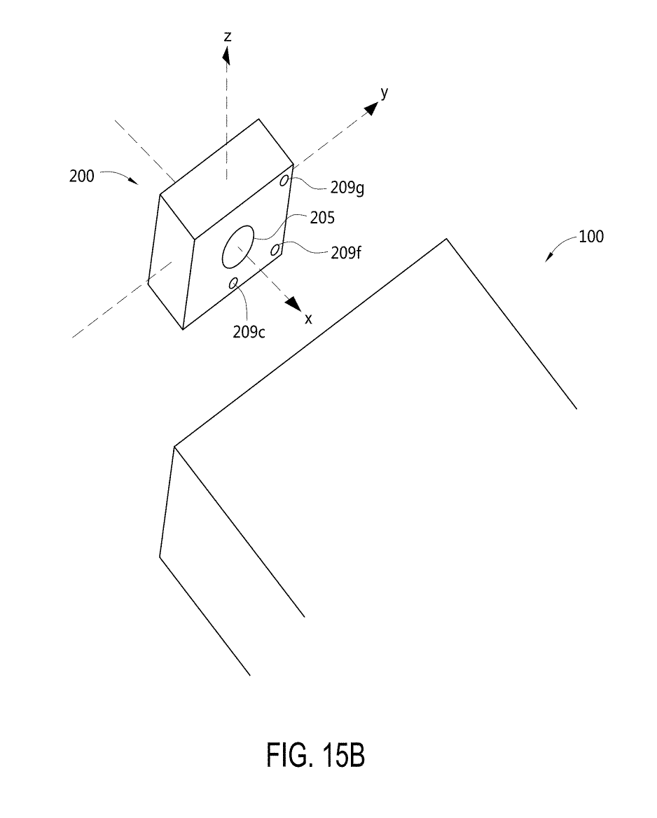

FIGS. 15A-15B illustrate another exemplary implementation for substantially aligning a charging connection 205 to a charging port 305. As shown in FIG. 15A, the emitter 309 may be positioned adjacent to the charging port 305. As shown in FIG. 15B, at least three detectors 209e, 209f, 209g may be positioned on a movable portion of the charging station. As shown, detector 209e is spaced apart from detector 209f along the y-axis and detector 209g is spaced apart from detector 209f along the z-axis. The 209e, 209f, 209g are positioned along an L-shaped path. Similar to the implementation described above, circuitry may be used to determine which of the detectors 209e or 209f detects the signal first. The detector 209e, 209f that detects the signal first is closer to the emitter 309 in the y-direction. The charging connection 205 may then be moved in the y-direction until both of the detectors 209e, 209f detect the signal at the same time or at least substantially the same time according to tolerance parameters. When the detectors 209e, 209f detect the signal at the same time, they are equidistant to the emitter 309 in the y-direction. In this way, the charging connection 205 may be aligned with the charging port 305 in the y-direction. The circuitry may be used to determine which of the detectors 209f or 209g detects the signal first. The detector 209f, 209g that detects the signal first is closer to the emitter 309 in the z-direction. The charging connection 205 may then be moved in the z-direction until both of the detectors 209f, 209g detect the signal at the same time or at least substantially the same time according to tolerance parameters. When the detectors 209f, 209g detect the signal at the same time, they are equidistant to the emitter 309 in the z-direction. In this way, the charging connection 205 may be aligned with the charging port 305 in the z-direction.

The positioning of the emitter 309 and detectors 209e, 209f, and 209g may be configured such that when the detectors 209e and 209f are equidistant from the detector 309 along the y-axis and the detectors 209f and 209g are equidistant from the detector 309 along the z-axis and the charging connection 205 is substantially aligned with the charging port 305 in the y-axis and z-axis. Thus, the charging connection 205 may be moved in the x-direction to couple to charging connection 205 to the charging port 305.

In some implementations, a method of charging an EV may be performed by positioning an EV a set distance from a charging station in the x-direction. The charging station may be positioned at the end of a parking stall. The EV may include a charging port that is located at or near the front of the vehicle. Thus, the EV may be automatically driven into the parking stall and be configured to stop when the vehicle is a set distance from the charging port in the x-direction. The charging station may be configured to communicate with the vehicle wirelessly. In some aspects, the charging station may be configured to detect an EV that is parked in front of it. In some aspects, the charging station may tell the EV how close to park to the charging station. In some aspects, the EV may be able to send charging level information to the charging station.

The method may continue by moving a charging connection of the charging station in three-dimensional space. In some aspects the charging station may be configured to first move the charging connection only along the z-axis. An emitter positioned on the vehicle, may emit a signal. At least two detectors, spaced apart along the z-axis may listen for the signal. The detectors may be moved until the detectors that are spaced apart along the z-axis receive the signal at the same time or at substantially the same time or within a threshold time difference. Thus, in some implementations, as shown for example in FIG. 8, linear actuator 885 may be configured to move up and/or down so as to translate the charging connector 205 in the z-direction. The liner actuator may be configured to stop when the z-axis detectors detect the emitted signal at the substantially the same time.

In some aspects, the charging station may be configured to listen and then move in discrete distances in discrete intervals. In other aspects, the charging station may move continuously in the z-direction until the detectors detect the signal from the emitter at the same time. In some aspects, circuitry may be used to determine the direction that the charging station should move. In general, the charging station should be moved in the direction that detected the signal later in time. For example, in FIG. 15B, if detector 209g detects the signal before 209f, the charging station and/or charging port may be configured to move upward in the z-direction. In some aspects, circuitry may be used to estimate and/or determine how far the charging station and/or charging port should move in response to the signal received by the detectors.

The method may continue by moving the charging connection and/or charging station along the y-axis. In some aspects the charging station may be configured to first move along the y-axis only after the charging connection is substantially aligned with the charging port along the z-axis. In other embodiments, the charging connection is first moved along the y-axis and then moved along the z-axis. In other embodiments, the charging connection may be configured to move along the z-axis and the y-axis at the same time.

An emitter positioned on the vehicle, may emit a signal. At least two detectors, spaced apart along the y-axis may listen for the signal. The detectors may be moved until the detectors that are spaced apart along the y-axis receive the signal at the same time or at substantially the same time. In some implementations, as best shown for example in FIG. 10, linear actuator 885 and linkage mechanism 905 may be configured to move the charging connection 205 back and forth along the y-axis.

After the charging connection is substantially aligned with the vehicle's charging port in the y and z directions, the charging connection may be moved along the x-axis to couple the charging connection with the charging port. Once a connection is made, the charging station may initiate charging. After the EV is charged, the charging connection may be moved away from the vehicle along the x-axis to uncouple the charging connection with the charging port. The charging connection may then be moved into a stored position.

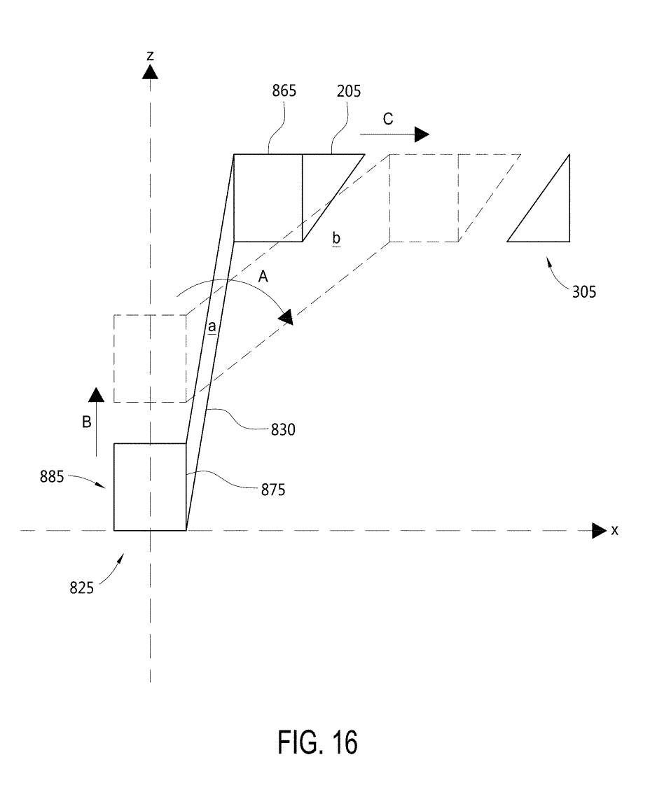

In some implementations, the movement of the charging connection in along the x-axis is performed in a “pecking” manner as described below. FIG. 16 schematically illustrates the movement of a charging connection 205 along the x-axis to couple with a charging port 305. As discussed above, a charging connection 205 may be disposed on a plate 865 that is coupled to one or more movable arms 830 (see, e.g., FIGS. 9-10). The movable arms 830 may couple the plate 865 to an actuating unit 825. The actuating unit 825 may include a linear actuator 885 configured to move the actuating unit 825 up and down along the z-axis. The actuating unit 825 may also include a linear actuator 885 a rotatable shaft 875 that may be coupled to a belt and pulley mechanism (not shown; see, e.g., FIGS. 9-10). The belt and pulley mechanism may rotate the one or more movable arms 830 along an arc in the z-x plane.

The charging connector 205 may be substantially aligned with the charging port 305 in both the z-axis and y-axis as discussed above (position “a” in FIG. 16). The charging station may then translate the charging connector 205 along the x-axis as follows: the one or more movable arms 830 may be configured to rotate along path “A” and moved in the z-direction (as shown by arrow “B”) and the x-direction (as shown by the arrow “C”). The combined upward movement by linear actuator 885, and the rotational movement of arm 830, causes the charging connector 205 to move along the x-axis and towards the charging port 305 (position “b” in FIG. 16). In this way, sufficient force may be achieved to mechanically and electrically couple the charging connector 205 to the charging port 305. In the final position (not shown) the charging connector 205 is coupled with the charging port 305. If a secured coupling is detected (e.g., by the coupling of a data port in the charging connector with a data port on the charging port 305) current may flow from the charging station to the vehicle.

In some aspects, if the charging connector 205 is not sufficiently coupled with the charging port 305, the charging connector 205 may be moved away from the charging port 305. The charging connector 205 may be re-aligned with the charging port 305 along the y and z axis, and the final movement in the x-direction may be tried again. The methods described above may be performed one or more times until a sufficient connection between the charging connector 205 and the charging port 305 is achieved.

According to various embodiments, the vehicle system controller 605 and the charging station system controller 640 can communicate with a cloud-based computing environment that collects, processes, analyzes, and publishes datasets. In general, a cloud-based computing environment is a resource that typically combines the computational power of a large grouping of processors and/or that combines the storage capacity of a large group of computer memories or storage devices. For example, systems that provide a cloud resource can be utilized exclusively by their owners, such as Google™ or Amazon™, or such systems can be accessible to outside users who deploy applications within the computing infrastructure to obtain the benefits of large computational or storage resources.

The cloud can be formed, for example, by a network of web servers with each server (or at least a plurality thereof) providing processor and/or storage resources. These servers can manage workloads provided by multiple users (e.g., cloud resource customers or other users). Typically, each user places workload demands upon the cloud that vary in real-time, sometimes dramatically. The nature and extent of these variations typically depend upon the type of business associated with each user.

Some of the above-described functions can be composed of instructions that are stored on storage media (e.g., computer-readable media). The instructions can be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic media, a CD-ROM disk, digital video disk (DVD), any other optical media, any other physical media with patterns of marks or holes, a RAM, a PROM, an EPROM, an EEPROM, a FLASHEPROM, any other memory chip or data exchange adapter, a carrier wave, or any other media from which a computer can read.

Various forms of computer-readable media can be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

While the present disclosure has been described in connection with a series of preferred embodiments, these descriptions are not intended to limit the scope of the disclosure to the particular forms set forth herein. The above description is illustrative and not restrictive. Many variations of the embodiments will become apparent to those of skill in the art upon review of this disclosure. The scope of this disclosure should, therefore, be determined not with reference to the above description, but instead should be determined with reference to the appended claims along with their full scope of equivalents. The present descriptions are intended to cover such alternatives, modifications, and equivalents as can be included within the spirit and scope of the disclosure as defined by the appended claims and otherwise appreciated by one of ordinary skill in the art. In several respects, embodiments of the present disclosure can act to close the loopholes in the current industry practices in which good business practices and logic are lacking because it is not feasible to implement with current resources and tools.

Spatially relative terms such as “under,” “below,” “lower,” “over,” “upper,” and the like, are used for ease of description to explain the positioning of one element relative to a second element. These terms are intended to encompass different orientations of the device in addition to different orientations than those depicted in the figures. Further, terms such as “first,” “second,” and the like, are also used to describe various elements, regions, sections, etc. and are also not intended to be limiting. Like terms refer to like elements throughout the description.

As used herein, the terms “having,” “containing,” “including,” “comprising,” and the like are open ended terms that indicate the presence of stated elements or features, but do not preclude additional elements or features. The articles “a,” “an” and “the” are intended to include the plural as well as the singular, unless the context clearly indicates otherwise.

The various embodiments described above, in accordance with the present invention, provide a means to couple a charging station's charging connection to a EV's charging port. Although this invention has been disclosed in the context of certain embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above.

Furthermore, the skilled artisan will recognize the interchangeability of various features from different embodiments. For example, the features of the charging station disclosed in the various embodiments can be switched between embodiments. In addition to the variations described herein, other known equivalents for each feature can be mixed and matched by one of ordinary skill in this art to construct analogous systems and techniques in accordance with principles of the present invention.

It is to be understood that not necessarily all objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

What is claimed is:

1. A method for autonomous connection of a charging station to a vehicle, the method comprising:
parking the vehicle in a position spaced away from the charging station in a longitudinal direction by a distance, the vehicle having a charging port and the charging station having a charging connection;
aligning the charging connection with the charging port with one or more actuators configured to move the charging connection in at least a transverse and lateral direction; and, after the charging connection is aligned with the charging port in at least the transverse and lateral directions;
moving the charging connection toward the charging port in the longitudinal direction to span the distance and couple the charging connection to the charging port.

2. The method of claim 1, wherein the aligning step comprises: first aligning the charging port with the charging port in the transverse direction and second, aligning the charging port with the charging port in the lateral direction.

3. The method of claim 1, wherein the aligning step comprises: detecting, with at least two detectors on the charging station, at least one signal emitted from the vehicle.

4. The method of claim 3, wherein the aligning step comprises: detecting, with at least three detectors on the charging station, at least one signal emitted from the vehicle.

5. The method of claim 4, wherein the signal is an ultrasonic signal.

6. A method for autonomous connection of a charging station to a vehicle, the vehicle having a charging port and the charging station having a charging connection, the method comprising:
detecting a pulse emitted by the parked vehicle by at least two detectors on the charging station;
determining a time interval between the detection of the pulse by the at least two detectors; and
moving the at least two detectors in at least one direction based at least on the determined time interval.

7. The method of claim 6, comprising detecting the pulse emitted by the parked vehicle by at least two detectors spaced apart in the transverse direction and detecting the pulse by at least two detectors spaced apart in the lateral direction.

8. The method of claim 6, comprising detecting the pulse emitted by the parked vehicle by at least three detectors arranged in an L-shaped configuration.

9. The method of claim 6, wherein the at least one direction is a transverse direction generally running from a ground surface to a top of the vehicle.

10. The method of claim 9, further comprising moving the at least two detectors in a lateral direction generally running in a direction that is parallel to a bumper of the vehicle.

11. The method of claim 10, further comprising moving the at least two detectors in a longitudinal direction generally running from the charging station to the vehicle.

12. The method of claim 6, wherein detecting the pulse emitted by the parked vehicle comprising detecting an ultrasonic sound wave.

13. The method of claim 6, further comprising stopping the movement of the two detectors when the time interval is about zero.

14. A charging station for an electric vehicle comprising:
a movable mount;
one or more actuators coupled to the mount and configured to translate the position of the mount through three dimensional space;
a charging connection coupled to the mount, the charging connection couplable to the vehicle's charge port and configured to charge the vehicle when connected to the charge port;
at least two detectors coupled to the mount, the detectors configured to receive at least one signal emitted from the vehicle; and
circuitry electrically connected to the at least two detectors and the one or more actuators; the circuitry configured to drive the motors in response to detection of the at least one signal.

15. The charging station of claim 14, wherein the at least two detectors comprise ultrasonic detectors.

16. The charging station of claim 14, comprising at least three detectors, wherein a first defector is spaced from a second detector in the transverse direction, and the third detector is spaced from the second detector in the lateral direction.

17. The charging station of claim 14, wherein the mount is coupled to one or more actuators by a rotating arm, the actuators configured to rotate the arm about a pivot point.

18. The charging station of claim 17, wherein the pivot point is coupled to one or more actuators configured to move the pivot point in the transverse direction.

19. The charging station of claim 18, wherein the mount is configured to move in the longitudinal direction by rotation of the arm about the pivot point and movement of the pivot point in the transverse direction.

20. The charging station of claim 14, wherein the charging connection is removably coupled to the mount to allow for manual charging.
